(19) United States
(12) Patent Application Publication
(10) Pub. No.: US 2009/0187634 A1
(43) Pub. Date: Jul. 23, 2009

(54) METHOD FOR FILTERING MESSAGES IN AN INSTANTANEOUS MESSAGING SYSTEM OF MOBILE TERMINALS, SYSTEM OF INSTANTANEOUS MESSAGING AND A SERVER TO IMPLEMENT THIS METHOD

(75) Inventor: Francois Colon, Marseille (FR)

Correspondence Address: HARNESS, DICKEY & PIERCE, P.L.C., P.O. BOX 828, BLOOMFIELD HILLS, MI, 48303, US

(73) Assignee: Miyowa, Marseille (FR)

(21) Appl. No.: 12/354,169

(22) Filed: Jan. 15, 2009

(30) Foreign Application Priority Data
Jan. 16, 2008 (FR) 0850258

(51) Int. Cl. G06F 15/16

(52) U.S. Cl. 709/206

(57) ABSTRACT

The invention relates to a method for filtering messages in an instant method system for mobile terminals, said system including an instant message server managing the exchange of messages between clients provided with mobile terminals and other users, said method being characterised by the fact that, upon reception of a message intended for the mobile terminal of a client, the message server directly analyzes said received message and:
if the analyzed message contains a sequence of characters corresponding, after comparison, to a specific sequence, the instant message server transmits such message to the mobile terminal of the client,
if the analyzed message does not contain this sequence of characters, the instant message server bars this message.

### CROSS-REFERENCE TO RELATED APPLICATIONS

This application claims priority to French Patent Application No. 0850258, filed on Jan. 16, 2008, which is incorporated by reference herein.

### TECHNICAL FIELD OF THE INVENTION

The invention relates to a method for filtering messages in an instant message system of mobile terminals. It also relates to an instant message system as well as a server used for implementing such method. The invention relates to the technical field of instant messages in mobile terminals and more particularly the technical field of the filtering of such instant message system.

### STATE OF THE ART

In the existing systems, instant message servers are able to deliver instant message services to mobile terminals connected to said servers and the clients of which have logged in. The message servers are more particularly configured for managing the exchange of messages between clients provided with mobile terminals and other users.

The mobile terminal instant message system makes it possible for clients to send written messages without having to mention the address of the destinee for each message sent as this is the case for SMS. In principle, each client defines a “buddy list” with whom he/she wishes to talk. The conversation can take place only if one or several users of the “buddy list” are connected to the instant message service. All the written messages appear at the same time on the screen of the mobile terminal of the client and the terminals of the users mentioned in the “buddy list” and connected to the instant message service. Thus, several persons can talk together. To efficiently manage a conversation through an instant message service, it is simpler to talk with only one part of one's “buddies” and to bar the messages from users with whom one does not wish to talk at that moment. As a matter of fact, if all the users talk at the same time, the conversation becomes difficult, all the more so on a mobile terminal.

When a client wishes to log in, a computer application installed in his or her mobile terminal sends a request for presence to the message server. The latter is then able to inform the other users of the “buddy list” of his or her presence, so that they can talk together. The client can manage his or her status as a function of a state of presence he/she has selected and of which he/she informed the message server. In order to limit the digit of persons with whom it is possible to talk, the client may for example inform the message server that he or she is available for some users but that he or she doesn't want to be disturbed by other users. The latter are thus not informed of the client's availability and will not talk with him or her. If users send messages to the client anyway, which often occurs, the instant message server is generally configured so as to transmit alert messages (SMS, MMS, e-mail) to said client. And the reception of such alert messages may interfere with the conversation that the client is having with the other users.

In order to limit the digit of persons he or she wants to talk to, each client can also define filtering rules so as to block the messages emitted by users mentioned on his or her “buddy list”, but whom he or she doesn't want to talk to. The filtering techniques are known to the person skilled in the art. In principle, these are filtering rules developed by instant message operators and integrated in the existing instant message servers. Generally, the client sends a request for filtering to the instant message server, which is intended to indicate that only the messages from some of the users of his or her “buddy list” can be communicated to him or her, and that the messages from the other users in his or her “buddy list” must be blocked.

A drawback of such a method lies in the fact that the request for filtering can be time consuming according to the digit of “buddies” mentioned in the “buddy list”. In addition, the client may make a mistake and erroneously indicate the filtering of one user whom he/she wishes to talk to and reversely. The risk of mistake is all the greater since the client generally has no way to check.

The documents US 2004/0143632 and US 2004/0143633 disclose a method for filtering an instant message service, the restrictions of which are associated with private codes. This method is applied to message systems for mobile terminals. A message server manages the exchange of messages between clients provided with mobile terminals and other users. Upon reception of a message intended for the mobile terminal of a client, the message server analyzes its database to know whether a private code has previously been supplied by the message sender. If the database contains such private code, the message server transmits the message to the mobile terminal of the client. If the database does not contain the private code, the message server sends a request to the sender so that the latter can give the private code. If the sender gives the correct private code, then the message server transmits the message to the mobile terminal of the client. If not so, the message server bars the message. The instant message server disclosed in the documents US2004/0143632 and US 2004/0143633 does not analyzes the initial message received, but the implementation of the answer to the request is time consuming.

As regards such drawbacks, the main technical problem that the invention is aiming at solving consists in providing a new filtering technique making it possible for client to receive only the messages sent by the “buddy” whom they want to talk to. Such technique is based on the analysis of a sequence of characters which is known to the authorized users. The invention also aims at simplifying the implementation of filtering rules in an instant message system.

### SUMMARY

The solution provided by the invention is a method for filtering messages in an instant message system for mobile terminals, said system including an instant message server managing the exchange of messages between clients provided with mobile terminals and other users. According to this message, upon reception of a message intended to the mobile terminal of the client, the instant message server directly analyzes the message received:

if the analyzed message contains a sequence of characters corresponding to a specific sequence of the comparison, the instant message server transmits the message to the mobile terminal of the client,

if the analyzed message does not contain this sequence of character, the instant message server bars the message.

With this solution, the client no longer has to inform the message server of who the users are, whose messages must be barred and those whose messages must be communicated. Now, only the users who know the specific sequence of characters are authorized to talk with the client, the others will have their messages blocked. In the following description and with the only aim of facilitating the understanding of the invention, the terms “specific sequence of characters” are replaced by the terms “magic word”. The instant message server may already have, for at least one client, a “buddy list” with associated filtering rules. In this case, upon reception of a message emitted by a user mentioned in the “buddy list” and intended for the mobile terminal of the client, the instant message server may examine the “buddy list” to check whether a filtering rule is associated with the user or not.

In case of a positive checking, the message server analyzes the message received to know whether the message received contains or does not contain the specific sequence of characters and can thus determine whether it contains the “magic word” or not. If the analyzed message contains the “magic word”, then the message server transmits it to the mobile terminal of the client. If not so, the message is barred. This characteristic makes it possible for a user knowing the “magic word” to talk with the client even though a filtering rule has initially been associated with him or her. Then, priority is preferably given to the “magic word” rather than to the filtering rules.

In the case when an instant message server examines the “buddy list” to check whether a filtering rule is associated with a user and in case of a negative checking, said message server analyzes the message received. If the analyzed message contains the “magic word”, the instant message server transmits the message to the mobile terminal of the client. If the analyzed message does not contain the “magic word”, the message server bars it. In an alternative embodiment, in the case when the instant message server examines the “buddy list” to check whether a filtering rule is associated with the user and in case of a negative checking, said server automatically transmits the message to the mobile terminal of the client. Then priority is preferably given to the absence of a filtering rule rather than to the “magic word”.

According to another advantageous characteristic of the invention making it possible for the client to choose his or her “magic word”, the mobile terminal of the client transmits the “magic word” to the message server, with said server storing the latter in a memory area. To inform the users whose messages have been barred, the instant message server may advantageously send an alert message to the terminals of said users. Similarly, to inform a client who logged off that a message containing the “magic word” has been received by the message server, the latter may send an alert message to said mobile terminal of the client if an analyzed message contains the “magic word”.

Another aspect of the invention relates to an instant message system for mobile terminals including an instant message server configured to manage the exchange of messages between clients provided with mobile terminals and other users, said system being remarkable in that the message server is provided with:

means for directly analyzing a message sent to a mobile terminal of the client and comparing the contents of such message with a specific sequence of characters forming a “magic word”,

means for transmitting said analyzed message to the mobile terminal of the client, if said message contains the “magic word”,

means for filtering said analyzed message, if said message does not contain the “magic word”.

According to particular embodiments:

the message server S includes:

for at least one client A, a “buddy list” 2A with associated filtering rules,

means for examining said “buddy list” 2A and checking whether a filtering rule is associated with one user B, C, D mentioned in said list having sent a message MB MC, MD to the mobile terminal TA of the client A,

and wherein means for analyzing said message MB, MC, MD is activated in case of a positive or negative checking;

the message server S includes:

for at least one client A, a “buddy list” 2A with associated filtering rules,

means for examining said “buddy list” 2A and checking whether a filtering rule is associated with a user B mentioned in said list having emitted a message MB to the mobile terminal TA of the client A, and wherein the means for transmitting said message MB to the mobile terminal TA of a client A is automatically activated in case of a negative checking;

the mobile terminal TA of the client A includes means for transmitting the specific sequence of characters to the message server S,

the message server S includes means for emitting an alert message 10C, 10D to the terminals TC, TD of the users C, D from which the messages MC, MD have been barred,

the message server S includes means for emitting an alert message 10A to the mobile terminal TA of the client A, said means being activated if an analyzed message contains the specific sequence of characters and if said client logged off.

Still another aspect of the invention relates to an instant message server configured for managing the exchange of messages between clients provided with mobile terminals and other users, said server being remarkable in that it incorporates a processing module including:

instructions for a direct analysis relating to the messages intended for the mobile terminal of the client;

instructions for commanding the transmission of the analyzed messages to the mobile terminal of the client if said messages contain the “magic word”,

instructions for barring the analyzed messages if they do not contain the “magic word”.

### BRIEF DESCRIPTION OF THE FIGURES

Other advantages and characteristics of the invention will be better understood upon reading the following description of a preferred embodiment and referring to the appended drawings which are given as indicative and non limitative examples and wherein:

FIG. 1 schematically shows an instant message system for mobile terminals according to the invention; and

FIG. 2 schematically shows an alternative embodiment, an instant message system for mobile terminals according to the invention wherein the client already associated filtering rules to his or her “buddy list”.

### DETAILED DESCRIPTION

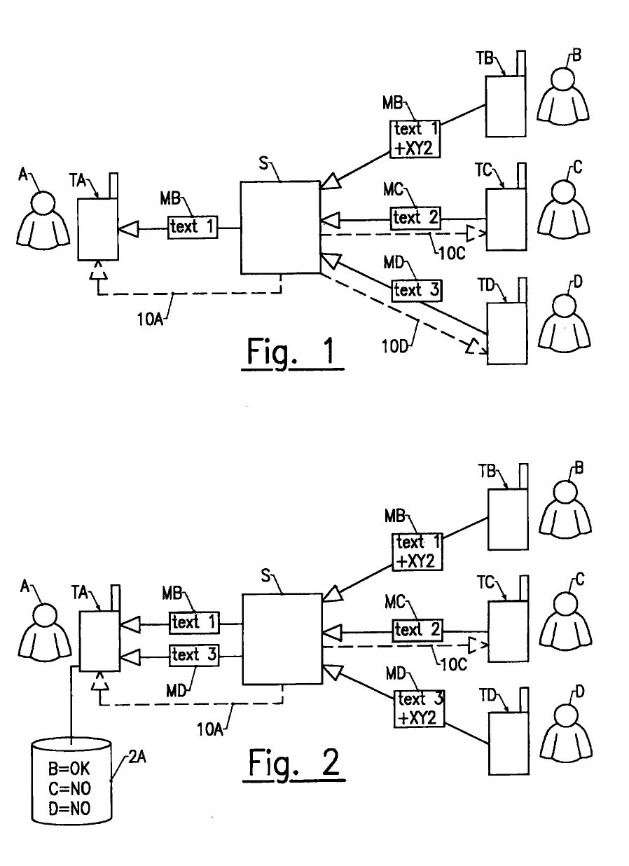

While referring to FIG. 1, the instant message system which is the object of the invention includes an instant message server S of a type known to the person skilled in the art and able to deliver to terminals which it is connected to basic instant messages services such as the management of messages exchanges, the management of presence status etc. In practice, the server S is associated with an instant message community. It is connected to a communication network (MSM®, Jabber®, Yahoo®) which is usually used for implementing the instant message services. In a well known manner, this message server is provided with a processor, a controller or any other equivalent means making it possible to manage the status of presence of the various users and more generally the various events affecting the system.

The mobile terminals of the clients used for implementing the invention can be mobile telephones or devices of the personal digital assistant type (PDA) or any other communication mobile terminal able to be connected to an instant message service. The mobile terminals TA are configured to be connected to a communication network of the MSM®, Jabber®, Yahoo®, etc type. This type of mobile terminal TA is used by the client A in the following description. The other terminals used by the other users are able to be connected to the instant message service. They can be mobile devices of the mobile telephone type, personal digital assistant (PDA) type or any other type but they can also be non mobile devices such as computers. This type of terminal TB, TC, TD is used by the users B, C, D in the following description. The latter are written in the “buddy list” 2A of the client A. They conventionally connect to the instant message server S to log in and talk to the client A.

While referring to FIG. 1, the message server S is connected to at least one mobile terminal TA of a client A and to the terminals TB, TC, TD of other users B, C, D so that the messages MB, MC, MD exchanged go through said server during the session. The messages MB, MC, MD are sent by the terminals TB, TC, TD of the users B, C, D and go through a communication network known to the person skilled in the art in the field of the instant message system. The messages MB, MC, MD are in principle texts including a succession of words and/or digits. According to the invention, the users B, C, D may know the “magic word” composed of a specific sequence of characters. The characters composing the “magic word” are in principle letters and/or digits and/or punctuation marks and/or new-line characters etc. While referring to FIG. 1, the “magic word” is for example composed of a sequence of letters and digits: “XY2”. This “magic word” is in principle communicated by the client A to the users whom he/she wishes to be able to talk to at any time. The “magic word” can be communicated to the users through a message of the SMS, MMS, email type or any other type and goes through a communication network known to the person skilled in the art.

While referring to the example in FIG. 1, the user B alone knows the “magic word”. Then, when the user B writes his or her message MB, he or she will incorporate this “magic word” into said message. This “magic word” can be incorporated at the beginning, in the middle or at the end of the message MB as the user chooses.

The client A also sends the “magic word” to the message server S via his or her mobile terminal TA. The transmission of the “magic word” to the server is carried out conventionally, the mobile terminal TA of the client A including means for transmitting it to the instant message server S. The “magic word” can be communicated to the message server S through a message of the SMS, MMS, email type or any other type and go through a communication network known to the person skilled in the art. When it is received, the message server S then stores this “magic word” in a memory area with a view to subsequently comparing it with the messages MB, MC, MD as described hereinafter.

When the messages MB, MC, MD are received by the message server S, the latter directly analyzes them so as to detect the presence of the “magic word”. This analysis is carried out while running one or several programs, sub-programs, micro-programs or any other equivalent means. In practice, the message server S incorporates a program including instructions for directly analyzing the message received MB, MC, MD.

According to several characters encoding standards such as ASCII, ISO8859, UNICODE, WINDOWS-12555 or any other one, each character of the “magic word” receives a number which can be encoded with one, two or a variable number of bytes. For example, the WINDOWS-12555 standard encodes the character “X” with number 58, the character “Y” with number 59 and the character “2” with number 32. Each “magic word” thus corresponds to a specific chain of numbers or code which can be analyzed by the means for analyzing the instant message server S.

The messages MB, MC, MD received by the message server S are also composed by an assembly of elements (words, digits) composed of a succession of characters (letters, digits, punctuation marks) encoded according to the same standard as the “magic word”. During the analysis of a message, the analyzing means will study each element of said message and check whether the encoding of one of these elements corresponds to the encoding of the “magic word”. If the analyzed message MB, MC or MD contains the “magic word”, the message server S transmits the message to the mobile terminal TA of the client A. If the analyzed message does not contain the “magic word”, the message server S bars the message. In the embodiment shown in FIG. 1, since the message MB alone contains the “magic word”, it is the only one to be transmitted to the client A, whereas the other messages MC and MD are barred.

In practice, the message server S incorporates a program including instructions for commanding the transmission of the analyzed messages to the mobile terminal TA of the client A, if said messages contain the “magic word”. The message MB is transmitted through conventional transmission means and reaches the mobile terminal TA of the client A through a communication network known to the person skilled in the art in the field of the instant message system. The messages MC and MD are barred by means able not to transmit them to the mobile terminal TA and possibly capable of storing them in a memory area on the message server S for them to be subsequently accessed to by the client A. In practice, the message server S incorporates a program including instructions for barring the messages MB and MD which do not contain the “magic word”.

While referring to FIG. 1, the message server S can send alert messages 10C, 10D to the terminals TC, TD of the users C, D whose messages MC, MD were barred. Thus, the users C, D are informed that they cannot talk to the client A. The alert messages 10C, 10D can be of the SMS, MMS, email types or any other type. They are transmitted through conventional transmission means and reach the terminals TC, TD of the users C, D through a communication network known to the person skilled in the art in the field of instant messages.

While referring to FIG. 1, the message server S can also emit an alert message 10A to the mobile terminal TA of the client A, if an analyzed message contains the sequence of characters and if the user of said terminal logged off. As a matter of fact, it can be interesting for the client A to be informed of the reception of a message containing the “magic word” even though he or she has not logged in. In practice, the means for transmitting the alert message 10A is activated only if a message analyzed by the message server S contains the “magic word”. The alert message 10A can be of the SMS, MMS, email types or any other type. It is transmitted through conventional transmission means and reaches the terminal TA through a communication network known to the person skilled in the art in the field of instant message system.

It is advantageous that the client A has the choice to activate or not the filtering function with the “magic word”. For this purpose, it can be determined that, in a normal operation, such function will not be activated. If a client A wishes to activate this function, a computer application positioned in his or her mobile terminal TA sends a request therefor to the message server S. The transmission of such request is made through communication protocols and networks well known to the person skilled in the art. As soon as this request is received, the message server S enables the means to analyze the presence of the “magic word” in the messages it received. In practice, such request contains a code or a part of a code able to activate the analysis means, when they are executed.

FIG. 2 shows an instant message system analog to that of FIG. 1 except that the client A already has associated filtering rules to the users B, C, D mentioned in his or her “buddy list” 2A. While referring to the example in FIG. 2, the client A only wishes to receive messages from the user B and only wishes to bar the messages from the users C and D. For this purpose, a computer application installed in the mobile terminal TA of the client A transmits a request to the message server S intended to indicate that the messages from the user B can be communicated to him or her (B=OK) and that the messages from the users C and D must be barred (C=NO; D=NO). This request is transmitted by communication protocols and networks well known to the person skilled in the art.

It can be interesting not to apply such filtering rules if the messages MB, MC, MD received by the message server S contain the “magic word”. For this purpose and according to the invention, when the message server S receives a message MB, MC, MD emitted by a user B, C, D mentioned in the “buddy list” 2A of the client A and to the mobile terminal TA of said client, said server examines said “buddy list” to check whether a filtering rule is associated with a user. Such step is carried out by running one or several programs, sub-programs, micro-programs or any other equivalent means. In practice, the message server S incorporates a program including instructions for examining the “buddy list” and for checking whether a filtering rule is associated with the user concerned.

In case of a positive checking, the message server S analyzes the received message to know whether it contains or not the “magic word”. The analyzing means is activated only in the case of a positive checking, with the analysis being carried out in the same manner as previously described. If the message contains the “magic word”, it will be transmitted to the client A. If not so, the message will be barred. In the exemplary embodiment shown in FIG. 2, the messages MB and MD contain the “magic word”, whereas the message MC does not. In this case, the message MB is transmitted to the mobile terminal TA of the client A; the message MC is barred; the message MD is transmitted to the mobile terminal TA of the client A, even though a filtering rule was associated with the user D. In the case when no filtering rule is associated to the user B and in the case when the message MB does not contain the “magic word”, two possible cases can be considered.

According to a first solution, the message MB is analyzed anyway, since the analyzing means are activated. As described hereabove, if this message MB contains the “magic word”, the message server S transmits it to the mobile terminal TA of the client A. If the message MB does not contain the “magic word”, the message server S bars it.

According to a second solution, the message server S does not analyze the message MB and automatically transmits it to the mobile terminal TA of the client A. In this case, the message analyzing means is not activated, contrary to the means for transmitting the message which is transmitted automatically. The chosen solution can be directly predefined by the operator of the message service and/or defined by the client A upon the activation of the barring function by the “magic word”.

1. A method for filtering messages in an instant message service for mobile terminals, said system including an instant message server managing the exchange of messages between clients equipped with mobile terminals and other users, wherein upon reception of a message intended for the mobile terminal of a client, the message server directly analyzes said received message and:
if the analyzed message contains a sequence of characters corresponding, after comparison, to a specific sequence, the instant message server transmits this message to the mobile terminal of a client; and
if the analyzed message does not contain this sequence of characters, the instant message server filters this message.

2. A method according to claim 1, wherein the message server includes, for at least one client, a “buddy list” with associated filtering rules, and wherein:
upon reception of a message emitted by a user mentioned in the “buddy list” and intended for the mobile terminal of said client, the message server examines said list to check whether a filtering rule is associated with such use; and
in case of a positive checking, the message server analyzes the received message:
if the analyzed message contains the specific sequence of characters, the message server transmits the message to the mobile terminal of the client, and
if the analyzed message does not contain this sequence of characters, the message server bars this message.

3. A method according to claim 2, wherein upon reception of a message emitted by a user mentioned in the “buddy list” and intended for the mobile terminal of the client, the message server examines said list to check whether a filtering rule is associated with such user, and wherein in case of negative checking, said message server analyzes the received message:
if the analyzed message contains the specific sequence of characters, the message server transmits this message to the mobile terminal of the client, and
if the analyzed message does not contain the sequence of characters, the message server bars this message.

4. A method according to claim 2, wherein upon reception of a message emitted by a user mentioned in the “buddy list” and intended for the mobile terminal of the client, the message server examines said list to check whether a filtering rule is associated with such user, and wherein in case of negative checking, the message server automatically transmits this message to the mobile terminal of the client.

5. A method according to claim 1, wherein the mobile terminal of the client transmits to the message server the specific sequence of characters, said server storing said sequence of characters in a memory area.

6. A method according to claim 1, wherein the message server emits an alert message intended for the terminals of the users whose messages have been barred.

7. A method according to claim 1, wherein the message server emits an alert message intended for the mobile terminal of the client if an analyzed message contains the specific sequence of characters and if said client logged off.

8. A mobile terminal instant message system comprising an instant message server operably managing an exchange of messages between clients provided with mobile terminals and other users, the message server further comprising:
an analyzer operably directly analyzing a message intended for a mobile terminal of a client and comparing the contents of this message with a specific sequence of characters forming a “magic word”;
a transmitter operably transmitting said analyzed message to the mobile terminal of the client if said message contains a specific sequence of characters; and
a filter operably for filtering said analyzed message if it does not contain the specific sequence of characters.

9. A system according to claim 8, wherein the message server further comprises:
for at least one client, a “buddy list” with associated filtering rules; and
means for examining said “buddy list” and checking whether a filtering rule is associated with a user mentioned in said list having emitted a message to said mobile terminal of the client;
wherein the analyzer is activated in case of a positive or a negative checking.

10. A system according to claim 8, wherein the message server further comprises:
for at least one client, a “buddy list” with associated filtering rules; and
an examiner operably examining said “buddy list” and checking whether a filtering rule is associated with a user mentioned in said list having emitted a message to the mobile terminal of the client;
wherein the transmitter is automatically activated in case of a negative checking.

11. A system according to claim 8, wherein the mobile terminal of the client includes a transmitter operably transmitting the specific sequence of characters to the message server.

12. A system according to claim 8, wherein the message server operably emits an alert message to the terminals of the users whose messages have been barred.

13. A system according to claim 8 wherein the message server operably emits an alert message to the mobile terminal of the client, said alert message emission being activated if an analyzed message contains the specific sequence of characters and if said client logged off.

14. An instant message server configured for managing the exchange of messages between clients provided with mobile terminals and other users in an instant message system according to claim 8, further comprising a processing module including:
instructions for directly analyzing the messages intended for the mobile terminal of a client;
instructions for commanding the transmission of the analyzed messages to the mobile terminal of the client if said messages contain a specific sequence of characters; an instructions for barring the analyzed messages if they do not contain said specific sequence of characters.
